(19) United States
(12) Patent Application Publication
(10) Pub. No.: US 2022/0091249 A1
(43) Pub. Date: Mar. 24, 2022

(54) Detection of an unknown rank-1 signal in interference and noise with unknown covariance matrix

(71) Applicant: US Gov't as represented by Secretary of Air Force, Wright-Patterson AFB, OH (US)

(72) Inventor: Ramachandran S. Raghavan, Centerville, OH (US)

(21) Appl. No.: 17/479,641

(22) Filed: Sep. 20, 2021

Related U.S. Application Data
(60) Provisional application No. 63/080,889, filed on Sep. 21, 2020.

(51) Int. Cl. G01S 13/524; G01S 7/02; G01S 7/292

(52) U.S. Cl. CPC G01S 13/5244; G01S 7/292; G01S 7/023

(57) ABSTRACT

A radar system provides a transmitter that transmits a sequence of transmitted pulses in a transmit beam, receiving antenna array comprised of more than one element, and a receiver communicatively coupled to the receiving antenna area to receive received signal that comprises in-phase and quadrature samples collected of a reflected version of the sequence of transmitted pulses. A signal processing and target detection module resolves a received signal-plus-interference into different range cells based on a time delay between the transmitted pulse and the received signal, wherein a response from a range cell to a transmitted pulse is due to a target within the transmit beam and moving at an unknown velocity. An interference suppression module suppresses interference and test for presence of a target tested at each of a set of hypothesized azimuth angles and Doppler frequencies.

### CROSS-REFERENCE TO RELATED APPLICATIONS

This application claims the benefit of priority under 35 U.S.C. § 119(e) to U.S. Provisional Application Ser. No. 63/080,889 entitled “Detection of an unknown rank-1 signal in interference and noise with unknown covariance matrix”, filed 21 Sep. 2020, the contents of which are incorporated herein by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### TECHNICAL FIELD

The present disclosure generally relates to radar systems.

### BACKGROUND

The standard approach for radar signal processing and target detection is to first resolve the received signal-plus-interference into different range cells based on the time delay between a transmitted pulse and the corresponding received signal. A response from a range cell to a transmitted pulse may be due to a target within the transmit beam and moving at an unknown velocity. The in-phase(I) and quadrature(Q) samples collected over a sequence of transmitted pulses and across the elements of the receiving antenna array correspond to the space-time samples of a coherent processing interval (CPI) for a specific range cell. Next, the interference must be suppressed and the presence of a target tested at each of a set of hypothesized azimuth angles and Doppler frequencies. In a surveillance context, there may be scenarios where a large portion of the surveillance area are likely to have no targets or where the target density may be small. Hypothesis testing in such cases can be performed on a relative coarse scale in azimuth angle and Doppler frequency. The coarse scale is defined by the appropriate space-time subspace that is spanned by several space-time steering vectors. Signal detection in this context is a hypothesis test for an unknown rank 1 signal given test vectors projected on the hypothesized subspace.

### DETAILED DESCRIPTION

The present disclosure considers the problem of detecting a signal that belongs to an unknown one dimensional subspace of C^{N×1} in additive interference-plus-noise whose covariance matrix is unknown. The interference-plus-noise is assumed to be modeled as a complex multivariate zero-mean random vector whose covariance matrix R, is estimated from signal-free training vectors. The hypothesis test, labeled the generalized Adaptive Coherence Estimator (GACE) involves two test vectors, both of which contain the unknown signal. The test statistic reduces to the ACE test statistic as the signal-to-interference-plus-noise ratio of any one of the test vectors increases without limit. In the limit of large number of training samples the GACE test statistic reduces to the magnitude square of the inner-product of a signal vector in additive statistically independent white noise vectors. Analytical expressions for the probability of false alarm and the probability of detection of the GACE test are derived and the test is shown to have the constant false alarm rate (CFAR) property. Sample results to illustrate the performance of the detector are provided and compared with the performance of the generalized likelihood ratio test (GLRT) for the specific problem, along with results on the sequential application of the GLRT and GACE.

Throughout the paper bold-face upper case letters denote matrices (and realizations of a random matrix), bold-face lower case letters denote vectors (and realizations of a random vector), light-face upper case denotes scalar random variable and and light-face lower case letters denote scalars (and realizations of a random variable). C^{M×P} denotes the set of complex M×P matrices, H(N) denotes the space of N×N hermitian positive definite matrices, I_{J} denotes the J×J Identity matrix, 0_{J×P} denotes a J×P matrix of zeros. Superscripts T and † denote the transpose operator and the complex transpose operator respectively, ⊗ denotes kronecker product. For Y∈C^{N×K}, vec(Y) denotes a vector of length NK obtained by concatenation of the K columns of Y, Tr[ ] denotes trace and the notation denotes ‘distributed as’. N_{c}(s,R) denotes a complex multivariate Gaussian distribution with mean s and covariance matrix R.

I. Introduction:

Non-parametric adaptive algorithms for the detection of a hypothesized signal vector in zero-mean gaussian interference whose covariance matrix is unknown have been researched extensively −. The relative advantages and shortcomings of the various detectors, all of which are known to have the Constant False Alarm Rate (CFAR) property are known. Of some interest are detectors similar to the Adaptive Coherence Estimator (ACE) algorithm which is known to have good properties of rejecting signals that are mismatched with the hypothesized signal −. In this paper, a more general form of ACE is developed which uses two test vectors both of which contain the same rank 1 signal in additive statistically independent interference-plus-noise whose covariance matrix is unknown. The signal is unknown to the receiver. GACE test statistic reduces to the standard ACE test statistic when the signal-to-interference-plus-noise ratio (SINR) of anyone of the two test vectors tends to infinity. Also of some interest is the case when the number of training samples becomes large in comparison to the length of the test vector. The GACE test in this limit is the magnitude square of the inner-product of two statistically independent white noise vectors plus a signal vector, the SNRs of the two vectors can be different.

Previous research in the area of non-parametric approaches for the detection of a signal that belongs to a known subspace in unknown interference as applied to radar is extensive and is not reviewed in this paper. The following papers and references within provide a sample for the interested reader −. Previous work in detecting a signal that belongs to a known one dimensional subspace in C^{N×1} in interference-plus-noise with unknown covariance matrix given multiple test vectors appears in. The effect of the hypothesized signal and the actual signal being mismatched on the generalized likelihood ratio test (GLRT) is considered in. The hypothesis testing problem for detecting an unknown signal in a set of column vectors that have additive statistically independent colored noise whose covariance matrices are same but unknown can be found in the multivariate statistics literature under the title of Wilk's likelihood ratio test (see and references within). In summary, the test statistic in the null (noise only) case is expressed as a product of statistically independent complex central beta random variables and for the alternative (signal present) hypothesis an analytical expression for the pdf of the statistic is available only for a rank 1 signal. In this case, the statistic is expressed as a product of statistically independent random variables, one of which has a complex non-central beta density and the remaining have complex central beta densities. Analytical results are not available for a signal with unspecified rank. Results are not available that show performance results expressed in terms of quantities such as the SINR loss factor and its pdf that are useful in the radar signal processing context.

The GLRT for the detection a set of M unknown, linearly independent signals in interference-plus-noise with unknown covariance matrix is derived in Appendix C of this paper. It is shown that the test statistic is constructed from the M largest eigenvalues of a positive definite P×P random matrix Z^{†}S⁻¹Z. The columns of the matrix Z∈C^{N×P} are the test vectors, S∈H(N) is proportional to the estimate of the interference-plus-noise covariance matrix and 1≤M≤P. The pdf of the GLRT statistic for a general M is not known and as such the detection performance of the test can only be characterized by simulations.

We provide a brief discussion of the radar signal processing context for the proposed approach. The standard approach for signal processing and target detection is to first resolve the received signal-plus-interference into different range cells based on the time delay between a transmitted pulse and the corresponding received signal. A response from a range cell to a transmitted pulse may be due to a target within the transmit beam and moving at an unknown velocity. The in-phase(I) and quadrature(Q) samples collected over a sequence of transmitted pulses and across the elements of the receiving antenna array correspond to the space-time samples of a coherent processing interval (CPI) for a specific range cell. Next, the interference must be suppressed and the presence of a target tested at each of a set of hypothesized azimuth angles and Doppler frequencies. In a surveillance context, there may be scenarios where a large portion of the surveillance area are likely to have no targets or where the target density may be small. Hypothesis testing in such cases can be performed on a relative coarse scale in azimuth angle and Doppler frequency. The coarse scale is defined by the appropriate space-time subspace that is spanned by several space-time steering vectors. Signal detection in this context is a hypothesis test for an unknown rank 1 signal given test vectors projected on the hypothesized subspace.

The rest of the paper is organized in the following manner, which is also a description of the novel aspects of this work: The hypothesis test for the problem of detecting a signal that belongs to an unknown one dimensional subspace of C^{N×1} in additive zero-mean multivariate complex gaussian interference whose covariance matrix is unknown is formulated in the next Section. The pdf of the GACE detection statistic, conditioned on the null hypothesis H₀ and the alternative hypothesis H₁ are summarized in Section II. The steps involved in the derivations of these pdfs are lengthy because two statistically independent multivariate gaussian random vectors: z₁∈C^{N×1} and z₂∈C^{N×1} and one N dimensional random matrix S with a central complex Wishart density are involved in evaluating the test statistic. This complicates the analysis of the probability of false alarm and probability of detection of the hypothesis test and to the best of our knowledge, these are new results. Details of the analysis has been moved to Appendices A and B without loss of continuity in the main text. A derivation of the GLRT for the given hypothesis test is included in Appendix C. Sample results are provided in Section IV to illustrate the relative detection performance of the GLRT and the GACE test. For small test vector lengths (N), the performance of the GLRT at low and moderate SINRs is considerably better than that of the GACE test. With all other quantities (such as the probability of false alarm, ratio of number of training vectors to the length of test vector etc) held constant, the difference in detection performance of the GLRT and GACE decreases as the test vector length increases before reaching a plateau. A sequential implementation of the GLRT followed by GACE is considered so as to combine the relative strengths of the GLRT in detection performance and of the GACE in rejecting mismatched signals. Summary and conclusions are provided in Section V.

II. The Hypothesis Test:

Let s∈C^{N×1} be an unknown unit-norm vector. The columns of Z∈C^{N×2} are two test vectors. Consider the binary hypothesis test below for X∈C^{N×2} and a=[a₁ a₂]^{T}∈C^{2×1}; |a₁|>0; |a₂|>0:

$$Z = \{ \begin{matrix}X & if {H}_{0} \\ X + {sa}^{T} & if {H}_{1}\end{matrix} \qquad ( 1 )$$

The columns of the matrix X denote the interference-plus-noise vectors in the two test vectors and are modeled as statistically independent zero-mean complex multivariate gaussian vectors with unknown covariance matrix R, which is assumed to be a hermitian positive definite matrix of size N. That is: vec(X) [symbol] (0, I₂⊗R). A set of training vectors Y∈C^{N×K} such that vec(Y) [symbol] (0, I_{K}⊗R) is assumed to be given for the purpose of estimating the unknown interference-plus-noise covariance matrix R.

For the assumed statistical model of the training vectors, \hat{R}=YY^{†}/K is a maximum likelihood (ML) estimate of the covariance matrix R and define S=YY^{†}. It is assumed that K≥N so that \hat{R} is a hermitian positive definite matrix with probability 1. Let zₙ∈C^{N×1}; n=1,2 denote the two columns of the test data matrix Z in equation (1). Conditioned on R=\hat{R} and with the mean vector of the interference-plus-noise being 0_{N×1} the conditional mean estimates ŝ₁=\hat{R}^{1/2}z₁ and ŝ₂=\hat{R}^{-1/2}z₂ are the conditional least square mean estimates of a₁R^{-1/2}s and a₂R^{-1/2}s respectively. Define the following unit-norm vectors:

u₁=S^{-1/2}z₁/\sqrt{z₁^{†}S⁻¹z₁}

u₂=S^{-1/2}z₂/\sqrt{z₂^{†}S⁻¹z₂} (2)

Based on prior knowledge of the ACE test, interest here is in characterizing the distribution of the statistic |u₁^{†}u₂|² under each hypothesis H₀ and H₁. For a given detection threshold 0<η≤1 consider the following decision rule:

$$W ( {z}_{1} , {z}_{2} , S ) = \vert α ( {z}_{1} , {z}_{2} , S ) {\vert}^{2} = \frac{\vert {z}_{1}^{†} {S}^{- 1} {z}_{2} {\vert}^{2}}{( {z}_{1}^{†} {S}^{- 1} {z}_{1} ) ( {z}_{2}^{†} {S}^{- 1} {z}_{2} )} η \qquad ( 3 )$$

The scalar function α above is used throughout the rest of this paper and has three arguments (two vector and one matrix) and is defined in equation (15). As the signal-to-interference-plus-noise ratio (SINR) of any one of the two test vectors increases to infinity i.e. z₁→a₁s or z₂→a₂s, equation (3) tends to the decision rule for the standard ACE test. For comparison with the ACE test, note that the null hypothesis for ACE is not the same as the null hypothesis of GACE. For comparison with ACE, the GACE test is always conditioned on hypothesis H₁ with the SINR of one test vector tending to infinity (say z₁→a₁s), the ACE null hypothesis is equivalent to setting the SINR of the second test vector to zero (i.e. a₂-+0) and the ACE alternative hypothesis is equivalent to setting |a₂|>0. In equation (3) the vectors z₁ and z₂ are both random as is the matrix estimate S. The pdf of the test statistic conditioned on hypothesis H₀ and H₁ is derived in two stages in Appendices A and B. In Appendix A, both test vectors z₁ and z₂ are fixed and the conditional pdf of the statistic in (3) is derived. Thus the only random quantity in Appendix A is the random matrix S. The results from Appendix A are used in Appendix B, where the conditioning on the test vectors z₁ and z₂ is removed to obtain expressions for the pdfs of the test statistic. This approach is possible because the training vectors that determine the matrix S are statistically independent of the test vectors z₁ and z₂. The probability of false alarm and the probability of detection for the test in (3) are obtained from the conditional pdfs. The analytical expressions are summarized in the next Section.

III. Detection and False Alarm Performance of Detector:

Analytical expressions for the probability of false alarm (P_{FA}) and probability of detection (P_{D}) for the decision rule in (3), are given in this Section. The expressions are derived in Appendices A and B.

The probability of false alarm for the decision rule in (3) is obtained by holding the random vectors z₁ and z₂ fixed at c and h respectively and finding the probability of [W(c,h,S)>η|H₀]. The matrix S being the only random quantity in the statistic. The conditional P_{FA} is shown in Appendix A to be a function of W(c,h,R). For z₁=c, z₂=h, note that the conditional probabilities [W(c,h,S)>η|W(C,h,R)=z; H₀] and [W(c,h,S)>η|W(C,h,R)=z; H₁] are identical, because the pdf of the random matrix S is identical for both hypotheses H₀ and H₁. Thus, the expression for the probability of detection has the same starting point. Equation (37) corresponds to the conditional probability [W(c,h,S)>η|H₀] and is repeated here for convenience:

$$P [ W ( c , h , S ) > η \vert W ( c , h , R ) = z ; {H}_{0} ] = 1 - {\sum }_{k = 0}^{L - 1} {E}_{k} ( z ) {f}_{β} ( 1 - η ; L - k , k + 2 ) {E}_{k} ( z ) = \frac{1}{( L + 1 )} {\sum }_{r = 0}^{k} ( \begin{matrix}L + r \\ r\end{matrix} ) \frac{{{z}^{r} ( 1 - z )}^{L + 1}}{{( 1 - η z )}^{r + L + 1}} {( 1 - η )}^{r} \qquad ( 4 )$$

The P_{FA} is obtained by removing the conditioning on the two random vectors z₁ and z₂ by averaging the conditional P_{FA} over the pdf of z=[W(z₁,z₂,R)|H₀]. This is obtained by substituting (4) and (40) in the following equation:

$${P}_{F A} = P [ W ( {z}_{1} , {z}_{2} , S ) > η \vert {H}_{0} ] = {\int }_{0}^{1} P [ W ( {z}_{1} , {z}_{2} , S ) > η \vert {z}_{1} = c , {z}_{2} = h , W ( c , h , R ) = z ; \\ {H}_{0} ] \times {f}_{W ( {z}_{1} , {z}_{2} , R )} ( z \vert {H}_{0} ) dz = 1 - {\sum }_{k = 0}^{L - 1} {H}_{k} {f}_{β} ( 1 - η ; L - k , k + 2 ) ; 0 < η < 1 \qquad ( 5 )$$

The coefficients Hₖ in equation (5) are given by the following sum:

$${H}_{k} = \frac{1}{( L + 1 ) !} {\sum }_{r = 0}^{k} \frac{( L + r ) ! {( 1 - η )}^{r}}{r !} \times [ {\int }_{0}^{1} [ \frac{{( 1 - z )}^{L + 1} {z}^{r}}{{[ 1 - z η ]}^{L + r + 1}} ] {f}_{β} ( z ; 1 , N - 1 ) dz ] ; k = 0 , 1 , … , ( L - 1 ) \qquad ( 6 )$$

In equations (5) and (6), f_{β}(z; m, n) denotes the complex central beta pdf with parameters m, n and is given by:

$${f}_{β} ( z ; m , n ) = \frac{( n + m - 1 ) !}{( n - 1 ) ! ( m - 1 ) !} {{z}^{m - 1} ( 1 - z )}^{n - 1} ; 0 \leq z \leq 1 \qquad ( 7 )$$

The integral in equation (6) is over the interval [0,1] and can be easily evaluated using readily available numerical integration packages.

As is evident from equations (5) and (6), the probability of false alarm does not depend on R, the unknown covariance matrix of the interference-plus-noise. Therefore the decision rule in (3) has the CFAR property.

The probability of detection for the decision rule in (3) is obtained in a similar manner and the steps involved in obtaining the conditional pdf of [z|H₁]=[W(z₁,z₂,R)|H₁] are given in Appendix B. Thus,

$${P}_{D} = P [ W ( {z}_{1} , {z}_{2} , S ) > η \vert {H}_{1} ] = {\int }_{0}^{1} P [ W ( {z}_{1} , {z}_{1} , S ) > η \vert {z}_{1} = c , {z}_{2} = h , W ( c , h , R ) = z ; \\ {H}_{1} ] \times {f}_{W ( {z}_{1} , {z}_{2} , R )} ( z \vert {H}_{1} ) dz = 1 - {\sum }_{k = 0}^{L - 1} {Q}_{k} {f}_{β} ( 1 - η ; L - k , k + 2 ) \qquad ( 8 )$$

The coefficients Qₖ in (8) are obtained in a manner similar to (6) except that the conditioning is on hypothesis H₁. Thus, with z=[W(z₁,z₂,R)|H₁] the coefficients Qₖ are given by:

$${Q}_{k} = \frac{1}{( L + 1 ) !} {\sum }_{r = 0}^{k} \frac{( L + r ) ! {( 1 - η )}^{r}}{r !} \times [ {\int }_{0}^{1} [ \frac{{( 1 - z )}^{L + 1} {z}^{r}}{{[ 1 - z η ]}^{L + r + 1}} ] f ( z \vert {H}_{1} ) dz ] ; k = 0 , 1 , … , ( L - 1 ) \qquad ( 9 )$$

The approach used to obtain the pdf of the random variable z=[W(z₁,z₂,R)|H₁] is explained in Appendix B.

Finally, for purposes of comparison the GLRT for a hypothesis test involving P test vectors comprising interference-plus-noise and more than one signals in the signal set is addressed in Appendix C. Under the alternative hypothesis H₁, the signal in each test vector is a linear sum of M, N-dimensional complex signals s₁, s₂, . . . , s_{M}. The M signals are linearly independent but unknown. The hypothesis test in equation (1) is for two test vectors (i.e. P=2) and one unknown signal (i.e. M=1). The GLRT (for M=1) evaluates the maximum eigenvalue λ₁ of the random matrix Z^{†}S⁻¹Z which is compared to a threshold η_{GLRT}. And so as given in equation (55) the GLRT for M=1 is:

λ₁η_{GLRT} (10)

In the next Section, sample results to illustrate the performance of the GACE test are provided and compared with the performance of the GLRT for the specific problem.

IV. Sample Results:

A plot of the P_{FA} as a function of threshold η as evaluated from equation (5) is shown in FIG. 1. Results obtained from analysis are shown as solid lines and compared with simulations which are denoted by symbols. For the simulations, independent realizations of the statistic W(z₁, z₂, S) were generated and the P_{FA} estimated from the outcomes of the independent trials. The number of independent trials used in the simulations were 10⁷. For N=7, the required threshold for P_{FA}=10⁻⁴ for example are: η=0.895, 0.8514 and 0.83244 for K=2N, 3N and 4N respectively.

FIG. 2 shows sample plots of the pdf of [z|H₁]=[W(z₁,z₂,R)|H₁] using the approach described in Appendix B. The SINR of the test vector z₁ is set at 10 dB and the SINR of the second test vector is varied as a parameter and shown in the figure legend. These results were also verified with a direct evaluation of [z|H₁]=[W(z₁,z₂,R)|H₁] and are not shown in the figure as there was good agreement between the two sets of results. The number of independent trials used to estimate the pdf was 10⁵. These results provide a validation of the statistical approach described in Appendix B. Simple properties such as the invariance of the pdf to commutation of SINR values: c₁=|a₁|²s^{†}R⁻¹s and c₂=|a₂|²s^{†}R⁻¹s between the two test vector were verified in all cases although not specifically indicated in the figure legend. As described in Section III, the pdf of [W(z₁,z₂,R)|H₁] forms the basis in equation (8) through (9) to evaluate the probability of detection of the test in (3).

With two test vectors in the hypothesis test, the probability of detection of the test in (3) is a function of c₁=|a₁|²s^{†}R⁻¹s and c₂=|a₂|²s^{†}R⁻¹s. In FIG. 3, SINR c₁ is set to 20 dB and the P_{D} is shown as a function of the SINR c₂ (in dB). Other parameters chosen are N=7 for three different cases of training vector sample size: K={14,21,28}. Appropriate thresholds as indicated earlier were chosen for the test in (3) such that P_{FA}=10⁻⁴. The results shown were obtained using equations (8) and (9) and verified with direct simulation of the test statistic which are denoted by symbols.

In FIG. 4, SINRs c₁ and c₂ are selected equal and P_{D} is shown as a function of the SINR (in dB) for two different tests: (i) Equation (3) and (ii) The GLRT for M=1 in equation (10). The thresholds for the tests were selected such that P_{FA}=10⁻⁴. As derived in Appendix C, the test statistic of the GLRT for M=1 is the maximum eigenvalue of the matrix: [z₁ z₂]^{†}S⁻¹[z₁ z₂]. The performance of the GLRT for multiple test vectors each of which has an arbitrarily scaled version of a known signal in additive statistically independent interference-plus-noise was derived in. In this paper the additive signal is unknown. We have not considered the problem of deriving the pdf of the test statistic for the GLRT conditioned on H₀ and H₁ in this paper. Therefore the required thresholds for the GLRT were obtained from simulations. For N=7, P_{FA}=10⁻⁴ and using 10⁷ independent trials the ordered threshold sequence η_{GLRT}={9.3534,3.0008,1.7066} corresponds to the following ordered sequence of training vector sample size: K={14,21, 28}. The results show that the detection performance of the GLRT is significantly better than that of the GACE test.

With all other quantities (such as P_{FA}, the ratio K/N etc) held constant, the difference in SINRs of the GACE and GLRT for a P_{D}=0.5 (say) decreases as the test vector length N increases before reaching a constant. This is shown in FIG. 5, which is a plot of P_{D} vs. SINR in dB (i.e c₁ in dB and c₁=c₂) for the GLRT and GACE test for N={7,14,21}. The number of vectors in the training set is K=2N and P_{FA}=10⁻⁴ in all cases. For a selected test vector length in N={7,14,21}, K=2N and P_{FA}, the required GLRT thresholds as estimated from 10⁷ independent trials are given by the ordered sequence: η_{GLRT}={9.3534,4.9266,3.7013} and the GACE thresholds as obtained from equation (5) are given by the ordered sequence: η={0.8950,0.6959,0.5577}.

There is still the effect of the two signal vectors in test vectors z₁ and z₂ being mismatched to consider. The sum of more than one linearly independent signal returns weighted arbitrarily for each CPI can cause the received signals for two CPIs to be mismatched. Note that the alternative hypothesis H₁ in (1) is that both test vectors contain the same unknown signal vector s∈C^{N×1}. For FIG. 6, the signals in the two test vectors are denoted by notations s₁∈C^{N×1} and s₂∈C^{N×1}, both of which have unit norm. For the results in FIG. 6, the two SINRs are set equal c₁=|a₁|²s₁^{†}R⁻¹s₁=c₂|a₂|²s₂^{†}R⁻¹s₂. The probability of detection for the test in (3) is a function of the signal mismatch metric cos²ψ defined below:

$${cos}^{2} ψ = \frac{{\vert {s}_{1}^{†} {R}^{- 1} {s}_{2} \vert}^{2}}{( {s}_{1}^{†} {R}^{- 1} {s}_{1} ) ( {s}_{2}^{†} {R}^{- 1} {s}_{2} )} \qquad ( 11 )$$

Analytical expression for the detection performance of the GACE test is not available at the present time and the results in FIG. 6 were obtained by simulation. The test statistic in (3) is cos²\hat{ψ}, an estimate of cos²ψ.

FIG. 6, shows a plot of the probability of detection of the test in (3) as a function of cos²ψ. The parameters chosen are N=7 and three different cases of training vector sample size of K=2N, 3N and K=4N. The parameters c₁ and c₂ are set equal to 25 dB. For the assumed SINRs, the detection performance of the GLRT in (55) is P_{D}=1 for all 0≤cos²ψ≤1 and is not shown in FIG. 6. And, the probability of detecting mismatched signals with cos²(ψ)<0.75 using the test in (3) is lower that 0.1 when P_{D}≈1 for the GLRT. Thus, FIG. 6 is also the detection performance of a sequential detection process, where the GLRT for M=1 in equation (10) is implemented as a first detector. The threshold for the GLRT is selected for the required P_{FA}. A decision of hypothesis H₀ by the first detector is a decision of H₀ for the combined detector. A decision of hypothesis H₁ by the first detector results in the next test in the sequence (i.e. the GACE test) to be performed. To summarize, a decision of H₀ for the combined detector results when the GLRT selects H₀ (the processing for GACE is not implemented in this case) and a decision of H₁ by the combined detector results when both GLRT and GACE detectors select H₁ as their decisions. This decision rule for the combined GLRT-GACE detector implies that the P_{FA} of the combined detector is the same as the P_{FA} of the GLRT. Therefore, it is possible to select the threshold of the GACE detector independently (and lower the threshold of the GACE detector independent of the P_{FA}). The primary purpose of lowering the threshold of the GACE detector is to allow the detection of matched signals with lower SINRs. The mismatched signal rejection property of the GACE is utilized at the same time. The lower threshold of GACE has no effect on the P_{FA} of the combined GLRT-GACE* detector (the asterisk indicates that the threshold chosen for GACE is lower than that required by a GACE detector operating alone with the same P_{FA} as the GLRT detector).

FIG. 7. shows a plot of P_{D} vs. cos²ψ for two SINRs: (i) c₁=c₂=20 dB and (ii) c₁=c₂=15 dB for GLRT, GACE* and combined GLRT-GACE*. The parameters are: N=7 and K=3N and GLRT threshold is selected for P_{FA}=10⁻⁴ and is η_{GLRT}=3.0008. The GACE* threshold is η=0.5, which is lower than the threshold of 0.8514 in FIG. 6. The result illustrates that a GLRT-GACE* detector combines the relative strengths of the GLRT in detection performance and of the GACE in rejecting mismatched signals.

Summary and Conclusions In this paper we have considered the problem of detecting an unknown complex vector of length N in additive interference-plus-noise whose covariance matrix R is unknown. Such a formulation may be useful in specific radar applications where the target density is known to be sparse. The hypothesis test considered uses two test vectors, both of which contain the unknown signal. The squared generalized cosine of the angle between the two basis vector, cos²\hat{ψ} is estimated and is the detection statistic of the test. The test in (3) is labeled as the generalized Adaptive Coherence Estimator (GACE) and reduces to the ACE test as the SINR of one of the two test vectors increases without limit. The GACE test was shown to have the constant false alarm rate (CFAR) property. Analytical expressions to characterize the P_{FA} and P_{D} of the detector were derived.

A GLRT for detecting signals that are a linear combination of M linearly independent but unknown signals in C^{N×1} in zero-mean complex gaussian interference-plus-noise with unknown covariance matrix, given P (1≤M≤P) test vectors was derived in Appendix C. The coefficients that weight the M signals in the test vectors are independent (i.e. the coefficient matrix has rank M). A comparison of the performance of GLRT (for P=2 and M=1) and GACE shows that at low and moderate SINRs, the detection performance of the GLRT is significantly better than that of GACE. With all other quantities (such as P_{FA}, the ratio K/N etc) held constant, the difference in SINRs of the GACE and GLRT for a P_{D}=0.5 (say) decreases as the test vector length N increases before reaching a constant. When the unknown signals in the two test vectors are linearly independent (referred to here as being mismatched), results show that the GACE test can reject such cases as the square of the generalized cosine of the angle between the two signals (defined in equation (11) decreases (i.e. the GACE detector has good mismatched signal rejection properties). On the other hand, the presence of mismatched signals with sufficient SINRs in one of the test vectors is not rejected by the GLRT (for M=1). A sequential detection test that uses GLRT followed by a GACE with a lower threshold was considered to illustrate that a GLRT-GACE* detector combines the relative strengths of the GLRT in detection performance and of the GACE in rejecting mismatched signals.

Appendix A

In this Appendix A, the conditional pdf of the statistic in (3) is derived with the vectors z₁ and z₂ fixed, so that the only random quantity in (3) is the random matrix S. The analysis in this appendix is therefore independent of hypothesis H₀ or H₁, since it is only the pdfs of the vectors z₁ and z₂ that depend on these hypotheses.

The random variable in equation (3) for z₁=c∈C^{N×1} and z₂=h∈C^{N×1} is denoted by W(c,h,S).

$$W ( c , h , S ) = \vert α ( c , h , S ) {\vert}^{2} = \frac{\vert {c}^{†} {S}^{- 1} h {\vert}^{2}}{( {c}^{†} {S}^{- 1} c ) ( {h}^{†} {S}^{- 1} h )} \qquad ( 12 )$$

Also define the quantity |γ(c,h,S)|² for future use as follows:

$$\vert γ ( c , h , S ) {\vert}^{2} = \frac{\vert α ( c , h , S ) {\vert}^{2}}{1 - \vert α ( c , h , S ) {\vert}^{2}} = \frac{W ( c , h , S )}{1 - W ( c , h , S )} \qquad ( 13 )$$

Define q∈C^{2×1}, t∈C^{2×1} and the complex valued constant α(c,h,R) as follows:

$$\begin{matrix}q = \sqrt{{c}^{†} {R}^{- {1}_{C}}} [ \begin{matrix}1 \\ 0\end{matrix} ] ; t = \sqrt{{h}^{†} {R}^{- 1} h} [ \begin{matrix}α ( c , h , R ) \\ \sqrt{1 - \vert α ( c , h , R ) {\vert}^{2}}\end{matrix} ] & ( 14 ) \\ α ( c , h , R ) = \frac{{c}^{†} {R}^{- 1} h}{\sqrt{( {c}^{†} {R}^{- 1} c ) ( {h}^{†} {R}^{- 1} h )}} & ( 15 )\end{matrix}$$

Then the distribution of W(c,h,S) is equivalent to that of the following:

$$W ( c , h , S ) \frac{\vert {q}^{†} {D}^{- 1} t {\vert}^{2}}{( {q}^{†} {D}^{- 1} q ) ( {t}^{†} {D}^{- 1} t )} \qquad ( 16 )$$

Where the 2×2 random matrix D has a central complex Wishart distribution with L+1 degrees of freedom, where L=(K−N+1).

Proof:

The quantity of interest is invariant to any reversible linear transform applied to all vectors. Let B=U^{†}R^{-1/2}, with U is a N×N unitary matrix with the first two columns given by: u₁=R^{-1/2}c\sqrt{c^{†}R⁻¹c} and u₂=h_{⊥}/∥h_{⊥}∥, where h_{⊥} is the component of R^{-1/2}h that is orthogonal to R^{-1/2}c and is given by: h_{⊥}=R^{-1/2}h (c^{†}R⁻¹h)R^{-1/2}c/(c^{†}R⁻¹c). The invariance property implies the following:

W(c,h,S)=W(Bc,Bh,BSB^{†}) (17)

Bc=\sqrt{c^{†}R⁻¹c}e_{1,N}

Bh=\sqrt{h^{†}R⁻¹h}(α(c,h,R)e_{1,N}+\sqrt{1−|α(c,h,R)|²}e_{2,N})

BY=\tilde{Y}

BSB^{†}=\tilde{S} (18)

e_{n,N} denotes a vector of length N whose n^{th} element is 1 and the remaining (N−1) elements are 0s. Pre-multiplication of the matrix Y by B results in whitening the columns of the matrix Y and so, vec(\tilde{Y}) N_{c}(0_{NK×1},I_{NK}). The complex scalar α(c,h,R) that appears in (18) is defined in equation (15).

Next, partition the transformed training matrix in the following manner: \tilde{Y}=[\tilde{Y}₁^{†}\tilde{Y}₂^{†}]^{†}; \tilde{Y}₁∈C^{2×K}; \tilde{Y}₂∈C^{(N-2)×K}. As a result of the first two equations in (18), it is useful to define vectors q∈C^{2×1} and t∈C^{2×1} as follows:

$$q = \sqrt{{c}^{†} {R}^{- {1}_{C}}} [ \begin{matrix}1 \\ 0\end{matrix} ] ; t = \sqrt{{h}^{†} {R}^{- 1} h} [ \begin{matrix}α ( c , h , R ) \\ \sqrt{1 - \vert α ( c , h , R ) {\vert}^{2}}\end{matrix} ] \qquad ( 19 )$$

And so, Bc=\tilde{q}=[q^{†}0_{1×(N-2)}]^{†} and Bh=\tilde{t}=[t^{†}0_{1×(N-2)}]^{†}. The hermitian positive definite matrix \tilde{S} evaluated from \tilde{Y} in (18) can be expressed in the following partitioned form:

$$\tilde{S} = [ \begin{matrix}{\tilde{S}}_{11} & {\tilde{S}}_{12} \\ {\tilde{S}}_{21} & {\tilde{S}}_{22}\end{matrix} ] = [ \begin{matrix}{\tilde{Y}}_{1} {\tilde{Y}}_{1}^{†} & {\tilde{Y}}_{1} {\tilde{Y}}_{2}^{†} \\ {\tilde{Y}}_{2} {\tilde{Y}}_{1}^{†} & {\tilde{Y}}_{2} {\tilde{Y}}_{2}^{†}\end{matrix} ] \qquad ( 20 )$$

Equation (12) can be written as follows:

$$\begin{matrix}W ( c , h , S ) = \frac{{\vert {c}^{†} {S}^{- 1} h \vert}^{2}}{( {c}^{†} {S}^{- 1} c ) ( {h}^{†} {S}^{- 1} h )} = \frac{{\vert {\tilde{q}}^{†} {\tilde{S}}^{- 1} \tilde{t} \vert}^{2}}{( {\tilde{q}}^{†} {\tilde{S}}^{- 1} \tilde{q} ) ( {\tilde{t}}^{†} {\tilde{S}}^{- 1} \tilde{t} )} \\ \frac{{\vert {q}^{†} {\tilde{S}}_{1.2}^{- 1} t \vert}^{2}}{( {q}^{†} {\tilde{S}}_{1.2}^{- 1} q ) ( {t}^{†} {\tilde{S}}_{1.2}^{- 1} t )}\end{matrix} \qquad ( 21 )$$

In the above the 2×2 hermitian positive definite matrix \tilde{S}_{1.2} is the Schur complement of \tilde{S}₂₂ in \tilde{S} and is given by:

$$\begin{matrix}{\tilde{S}}_{1.2} = {\tilde{S}}_{11} - {\tilde{S}}_{12} {\tilde{S}}_{22}^{- 1} {\tilde{S}}_{21} \\ = {\tilde{Y}}_{1} [ {I}_{K} - {{\tilde{Y}}_{2}^{†} [ {\tilde{Y}}_{2} {\tilde{Y}}_{2}^{†} ]}^{- 1} {\tilde{Y}}_{2} ] {\tilde{Y}}_{1}^{†}\end{matrix} \qquad ( 22 )$$

The rank of matrix \tilde{Y}₂∈C^{(N-2)×K} is (N−2) and therefore the nullspace of \tilde{Y}₂ is a subspace in C^{K×1} of dimension K−(N−2)=L+1. Note that the non-zero eigenvalues of matrix \tilde{Y}₂^{†}[\tilde{Y}₂\tilde{Y}₂^{†}]⁻¹\tilde{Y}₂ are the same as the eigenvalues of \tilde{Y}₂\tilde{Y}₂^{†}[\tilde{Y}₂\tilde{Y}₂^{†}]⁻¹=I_{N-2}, which is 1 with multiplicity (N−2). And so, the eigenvalues of the matrix within the parenthesis in (22) are 0s with multiplicity (N−2) and 1s with multiplicity (L+1).

Let the orthonormal set of vectors aₙ∈C^{K×1}; n=1, 2, . . . , K, denote the eigenvectors of matrix: [I_{K}−\tilde{Y}₂^{†}[\tilde{Y}₂\tilde{Y}₂^{†}]⁻¹\tilde{Y}₂], such that the eigenvectors aₙ; n=1, 2, . . . , (L+1) correspond to eigenvalue 1 and the vectors aₙ; n=(L+2), . . . , K correspond to eigenvalues 0. Thus:

$$[ {I}_{K} - {{\tilde{Y}}_{2}^{†} [ {\tilde{Y}}_{2} {\tilde{Y}}_{2}^{†} ]}^{- 1} {\tilde{Y}}_{2} ] = {\sum }_{n = 1}^{L + 1} {a}_{n} {a}_{n}^{†} \qquad ( 23 )$$

And substituting (23) in (22),

$${\tilde{S}}_{1.2} = {\tilde{Y}}_{1} [ {\sum }_{n = 1}^{L + 1} {a}_{n} {a}_{n}^{†} ] {\tilde{Y}}_{1}^{†} = {VV}^{†} = D ∈ ℋ ( 2 ) \qquad ( 24 )$$

In equation (24), V=\tilde{Y}₁A, where the columns of matrix A∈C^{K×(L+1)} are the orthonormal vectors aₙ; n=1, 2, . . . , (L ±1). In equation (24) \tilde{Y}₁∈C^{2×K} and vec(\tilde{Y}₁)N_{c}(0_{2K×1},I_{2K}). It follows therefore that the columns of V∈C^{2×(L+1)} are iid zero-mean complex white gaussian random vectors and vec(V)N_{c}(0_{2(L+1)×1},I_{2(L+1)}) and from, the 2×2 matrix D=VV^{†} has a central complex Wishart pdf with L+1 degrees of freedom.

The conditional distribution of W(c,h,S) for fixed element d₂₂ of matrix D∈ [symbol] (2) in equation (24) is [W(c,h,S)|d₂₂]1−β_{L,1}(|γ(c,h,R)|²d₂₂), where |γ(c,h,R)|²=|α(c,h,R)|²/(1|α(c,h,R)|²).

Proof:

The matrix D=VV^{†} in its partitioned form can be expressed as follows:

$$D = [ \begin{matrix}{d}_{11} & {d}_{12} \\ {d}_{21} & {d}_{22}\end{matrix} ] = [ \begin{matrix}{v}_{1} {v}_{1}^{†} & {v}_{1} {v}_{2}^{†} \\ {v}_{2} {v}_{1}^{†} & {v}_{2} {v}_{2}^{†}\end{matrix} ] \qquad ( 25 )$$

In the above equation the matrix V∈C^{2×(L+1)} is partitioned as V=[v₁^{†}v₂^{†}₂]^{†}, where v₁ [symbol] (0_{1×(L+1)},I_{(L+1)}) and v₂ [symbol] (0_{1×(L+1)},I_{(L+1)}) and are statistically independent. Substituting equation (24) in the last line of equation (21) and using results for inverse of partitioned matrix the three terms for evaluating W(c,h,S) in (21) can be expressed as follows:

$${q}^{†} {D}^{- 1} t = \frac{\sqrt{( {c}^{†} {R}^{- 1} c ) ( {h}^{†} {R}^{- 1} h )}}{{d}_{1.2}} \times ( α ( c , h , R ) - \sqrt{1 - {\vert α ( c , h , R ) \vert}^{2}} {d}_{12} {d}_{22}^{- 1} ) \\ {q}^{†} {D}^{- 1} q = ( {c}^{†} {R}^{- 1} c ) {d}_{1.2}^{- 1} \\ {t}^{†} {D}^{- 1} t = \frac{( {h}^{†} {R}^{- 1} h )}{{d}_{1.2}} \times ( {\vert ( α ( c , h , R ) - {d}_{12} {d}_{22}^{- 1} \sqrt{1 - {\vert α ( c , h , R ) \vert}^{2}} ) \vert}^{2} + ( 1 - {\vert α ( c , h , R ) \vert}^{2} ) {d}_{1.2} {d}_{22}^{- 1} \qquad ( 26 )$$

d_{1.2} is the Schur complement of d₂₂ in D and is given by:

d_{1.2}=(d₁₁−d₁₂d₂₂⁻¹d₂₁) (27)

The quantity |γ(c,h,R)|² was defined in equation (13) in terms of |α(c,h,R)|². With the random matrixes \tilde{S}_{1.2} and D being statistically equivalent as per equation (24), substitution for all the quantities in equation (21) using (26) results in the following:

$$W ( c , h , S ) = \frac{X}{1 + X} \\ Q = 1 - W ( c , h , S ) = {( 1 + X )}^{- 1} \qquad ( 28 )$$

In (28) a random variable Q is defined for future use and the random variable X is defined as follows:

$$\begin{matrix}X = \frac{{d}_{22} {\vert γ ( c , h , R ) - {d}_{12} {d}_{22}^{- 1} \vert}^{2}}{{d}_{1.2}} \\ = \frac{{\vert γ ( c , h , R ) \sqrt{{d}_{22}} - {d}_{12} {d}_{22}^{- 1 \text{/} 2} \vert}^{2}}{{d}_{1.2}}\end{matrix} \qquad ( 29 )$$

For fixed d₂₂, the random variables d_{1.2} and d₁₂ are statistically independent with conditional distribution: d_{1.2}χ_{L}² and d₁₂/\sqrt{d₂₂} [symbol] (0,1), which leads to the conditional distribution of β_{L,1}(|γ|²d₂₂) for Q=1−W(c,h,S).

A summary of proof to show that for fixed d₂₂ the random variables d_{1.2} and d₁₂ are statistically independent with conditional distribution: d_{1.2}χ_{L}² and d₁₂/\sqrt{d₂₂} [symbol] (0, 1) is as follows: Write d_{1.2}=(d₁₁−d₁₂d₂₂⁻¹d₂₁)=v₁[I_{L+1}−v₂^{†}[v₂v₂^{†}]⁻¹v₂]₁^{†}. The matrix within the outer pair of parenthesis is idempotent with eigenvalue 1 with multiplicity L and a single eigenvalue 0. The eigenvector corresponding to the eigenvalue 0 is the normalized vector:

b₁=v₂^{†}/\sqrt{d₂₂}∈C^{(L+1)×1}.

Let the orthonormal set of vectors: {b₂, b₃, . . . , b_{L+1}}∈C^{(L+1)×1} be orthogonal to the vector b₁. Then,

$$\begin{matrix}{v}_{1} [ {I}_{L + 1} - {{v}_{2}^{†} [ {v}_{2} {v}_{2}^{†} ]}^{- 1} {v}_{2} ] {v}_{1}^{†} = {v}_{1} [ {\sum }_{n = 2}^{( L + 1 )} {b}_{n} {b}_{n}^{†} ] {v}_{1}^{†} \\ = {\sum }_{n = 2}^{( L + 1 )} {\vert {v}_{1} {b}_{n} \vert}^{2} {χ}_{L}^{2}\end{matrix} \qquad ( 30 )$$

The last expression above is the sum of the magnitude-square of L iid zero-mean, complex gaussian random variables with unit variance and therefore has a central Chi-squared density with L complex degrees of freedom.

Similarly the quantity d₁₂d₂₂⁻¹=v₁v₂^{†}[v₂v₂^{†}]⁻¹ in equation (29). For fixed v₂, the complex scalar quantity v₁v₂^{†}=\sqrt{d₂₂}v₁ b₁ and involves no terms of the form v₁bₙ; n=2, 3, . . . , (L+1) that appear in equation (30). And so conditionally, the random variable v₁v₂^{†}[v₂v₂^{†}]⁻¹ has a zero-mean complex Gaussian density and is statistically independent of the random variables v₁bₙ; n=2, 3, . . . , (L+1). The conditional variance is given by:

E[[v₂v₂^{†}]⁻¹v₂v₁^{†}][v₁v₂^{†}[v₂v₂^{†}]⁻¹|v₂]=[v₂v₂^{†}]⁻¹=d₂₂⁻¹ (31)

In the above E[v₁^{†}v₁|v₂]=I_{L+1}. And so, for fixed v₂ which fixes d₂₂=v₂v₂^{†}, the random variable: d₂₂|γ(c,h,R)−d₁₂d₂₂⁻¹|²χ₁²(|γ(c,h,R)|²d₂₂). It follows that conditioned on a fixed d₂₂, 1−W(c,h,S)β_{L,1}(|γ|²d₂₂).

Using the results in Propositions (??) and (??), conditional pdf of Q=1−W is given by:

$${f}_{Q} ( q \vert {d}_{22} ) = {e}^{- gq} {\sum }_{k = 0}^{L} ( \begin{matrix}L \\ k\end{matrix} ) \frac{L ! {g}^{k}}{( L + k ) !} {f}_{β} ( q ; L , k + 1 ) ; 0 \leq q \leq 1 \qquad ( 32 )$$

In equation (32), g=|γ(c,h,R)|²d₂₂
The central beta pdf f_{β}(q; L, k+1) that appears in the above equation is defined in equation (7)
The conditioning can be removed above by averaging over the PDF of d₂₂=v₂v₂^{†}χ_{L+1}². And so,

$$\begin{matrix}{f}_{Q} ( q ) = {\int }_{0}^{∞} {f}_{Q} ( q \vert {d}_{22} = v ) \frac{{v}^{L}}{L !} {e}^{- v} dv \\ = \frac{L {q}^{- 1}}{{( 1 + {\vert γ ( c , h , R ) \vert}^{2} q )}^{L + 1}} \times \\ [ {\sum }_{k = 0}^{L} {\frac{( L + k ) !}{( L - k ) ! {( k ! )}^{2}} [ \frac{{\vert γ ( c , h , R ) \vert}^{2} ( 1 - q )}{1 + {\vert γ ( c , h , R ) \vert}^{2} q} ]}^{k} ] ; 0 \leq q \leq 1\end{matrix} \qquad ( 33 )$$

The above pdf of Q is valid for K≥N.

The cumulative distribution function (CDF) of random variable Q can be obtained in a similar manner. The CDF of a random variable yβ_{m,n}(c) can be written as follows:

$$P [ y \leq {y}_{0} ] = 1 - \frac{1}{( m + n )} {\sum }_{k = 0}^{m - 1} {f}_{β} ( {y}_{0} ; m - k , n + k + 1 ) {G}_{k + 1} ( {cy}_{0} ) \\ {G}_{k + 1} ( x ) = {e}^{- x} {\sum }_{n = 0}^{k} \frac{{x}^{n}}{n !} \qquad ( 34 )$$

In the above equation f_{β}(y;m,n) denotes the complex central beta pdf with parameters m, n defined in (7).

Conditioned on a fixed d₂₂, the random variable Qβ_{L,1}(|γ(c,h,R)|²d₂₂). Using equation (34) and d₂₂χ_{L+1}², the conditioning on d₂₂ can be removed. Noting that Q=1−W(c,h,S), and for a given threshold 0<η<1, the probability P[W(c,h,S)>η]=P[Q<1−η] and so for both hypotheses H₀ and H₁:

$$( 35 )$$

$$\begin{matrix}P [ W ( c , h , S ) > η \vert {H}_{0} or {H}_{1} ] = 1 - \frac{1}{L + 1} {\sum }_{k = 0}^{L - 1} {f}_{β} ( 1 - η ; L - k , k + 2 ) \\ [ {\int }_{0}^{∞} \frac{{v}^{L} {e}^{- v}}{L !} {G}_{k + 1} ( ( 1 - η ) {\vert γ ( c , h , R ) \vert}^{2} v ) dv ] \\ = 1 - {\sum }_{k = 0}^{L - 1} {E}_{k} {f}_{β} ( 1 - η ; L - k , k + 2 )\end{matrix}$$

The quantity Eₖ is the following sum:

$${E}_{k} = \frac{1}{( L + 1 )} [ {\sum }_{r = 0}^{k} ( \begin{matrix}L + r \\ r\end{matrix} ) \frac{{[ {\vert γ ( c , h , R ) \vert}^{2} ( 1 - η ) ]}^{r}}{{[ 1 + {\vert γ ( c , h , R ) \vert}^{2} ( 1 - η ) ]}^{r + L + 1}} ] ; \\ k = 0 , 1 , ⋯ , ( L - 1 ) \qquad ( 36 )$$

Let z=|α(c,h,R)|² and so from equation (13), |γ(c,h,R)|²=z/(1−z). The coefficients Eₖ can be expressed in terms of z=|α(c,h,R)|² and equation (35) can be rewritten as follows:

$$P [ W ( c , h , S ) > η \vert W ( c , h , R ) = z ; {H}_{0} ] = 1 - {\sum }_{k = 0}^{L - 1} {E}_{k} ( z ) {f}_{β} ( 1 - η ; L - k , k + 2 ) \\ {E}_{k} ( z ) = \frac{1}{( L + 1 )} {\sum }_{r = 0}^{k} ( \begin{matrix}L + r \\ r\end{matrix} ) \frac{{{z}^{r} ( 1 - z )}^{L + 1}}{{( 1 - η z )}^{r + L + 1}} {( 1 - η )}^{r} \qquad ( 37 )$$

Appendix B:

In this Appendix, the probability of the random variable on the left hand side of (3) exceeding a pre-set threshold is derived by using the result in equations (35) and (36) of Appendix A. The conditioning z₁=c and z₂=h is removed from equation (12). The results will depend on the hypothesis H₀ and H₁ because the pdf of vectors z₁ and z₂ are dependent on the hypotheses.

Setting c=z₁ and h=z₂ in (12), the resulting random variable is invariant to the operation of premultiplication all vectors by the matrix U^{†}R^{-1/2}. The first column of the unitary matrix U is R^{-1/2}s/\sqrt{s^{†}R⁻¹s}, which as a result is the axis corresponding to the first coordinate. The random vectors U^{†}R^{-1/2}z₁ and U^{†}R^{-1/2}z₂ are statistically independent and are distributed as follows for n=1,2:

$${U}^{†} {R}^{- 1 \text{/} 2} {z}_{n} \{ \begin{matrix}{𝒩}_{c} ( 0 , {I}_{N} ) & if {H}_{0} \\ {𝒩}_{c} ( {a}_{n} \sqrt{{s}^{†} {R}^{- 1} s} {e}_{1 , N} , {I}_{N} ) & if {H}_{1}\end{matrix} \qquad ( 38 )$$

Define the random vectors: ũₙ=U^{†}R^{-1/2}zₙ; n=1, 2. First, consider the null hypothesis H₀: For a fixed ũ₁/∥ũ₁∥=v∈C^{N×1}; ∥v∥=1, the random variable |α|² can be written as follows:

$$[ {\vert {α ( {z}_{1} , {z}_{2} , R )}^{2} \vert}^{2} \vert {\tilde{u}}_{1} \text{/} ‖ {\tilde{u}}_{1} ‖ = v , {H}_{0} ] = \frac{{\vert {v}^{†} {\tilde{u}}_{2} \vert}^{2}}{{‖ {\tilde{u}}_{2} ‖}^{2}} = \frac{{\vert {w}_{1} \vert}^{2}}{{\vert {w}_{1} \vert}^{2} + {‖ {w}_{2} ‖}^{2}} \\ {( 1 + \frac{{χ}_{N - 1}^{2}}{{χ}_{1}^{2}} )}^{- 1} {β}_{1 , N - 1} \qquad ( 39 )$$

In equation (39), conditioned on hypothesis H₀, the random variable [w₁|H₀]=v^{†}ũ₂ [symbol] (0, 1) and the projection of random vector ũ₂ on the orthogonally complementary subspace of v in C^{N×1} defines the random vector w₂. For hypothesis H₀, w₁ and w₂ are statistically independent and w₂ [symbol] (0_{N×1},I_{N}−vv^{†}). Therefore, conditioned on a fixed ũ₁/∥ũ₁∥=v∈C^{N×1}; ∥v∥=1 and hypothesis H₀, we have w₁χ₁² and ∥w₂∥²χ_{N-1}². Because the random vector z₁ is statistically independent of z₂, the conditional distribution in (39) is valid, irrespective of v. The result in (39) is therefore the distribution under hypothesis H₀ of |α(z₁,z₂,R)|² defined in (15) for c=z₁ and h=z₂:

[w(z₁,z₂,R)|H₀]=[|α(z₁,z₂,R)|²|H₀]β_{1,N-1} (40)

The probability of false alarm P_{FA} for the decision rule in (3) is obtained by replacing the quantity y(c,h,R) in equations (33) and (35) by the random variable γ(z₁,z₂,R) conditioned on hypothesis H₀ and using equation (40).

Under hypothesis H₁, write ũ₁/∥ũ₁∥=e^{jϕ}^{₁} cos θe_{1,N}+e^{jϕ}^{₂} sin θ v_{⊥}, where v_{⊥}∈c^{N×1}, ∥v_{⊥}∥=1, e_{1,N}^{†}v_{⊥}=0 and angles ϕ₁ and ϕ₂ account for the real and imaginary components of each term and as such the domain of angle θ can be restricted to 0≤θ≤π/2. From equation (39), [U^{†}R^{-1/2}zₙ|H₁] [symbol] (aₙ\sqrt{s^{†}R⁻¹s}e_{1,N},I_{N}), we have cos²θ=x/(x y), where xχ₁²(|a₁|²s^{†}R⁻¹s) and yχ_{N-1}². Thus:

$$[ {cos}^{2} θ \vert {H}_{1} ] {( 1 + \frac{{χ}_{N - 1}^{2}}{{χ}_{1}^{2} ( {\vert {a}_{1} \vert}^{2} {s}^{†} {R}^{- 1} s )} )}^{- 1} \\ [ {sin}^{2} θ \vert {H}_{1} ] {( 1 + \frac{{χ}_{1}^{2} ( {\vert {a}_{1} \vert}^{2} {s}^{†} {R}^{- 1} s )}{{χ}_{N - 1}^{2}} )}^{- 1} \\ {β}_{N - 1 , 1} ( {\vert {a}_{1} \vert}^{2} {s}^{†} {R}^{- 1} s ) \qquad ( 41 )$$

Write [ũ₂|H₁]=x₁e_{1,N}+x₂, where x₁ [symbol] (a₂\sqrt{s^{†}R⁻¹s}, 1) and x₂ [symbol] (0_{N×1},I_{N}−e_{1,N}e_{1,N}^{†}). Note that e_{1,N}^{†}x₂=0 and x₁ and x₂ are statistically independent. The pdf of random variable |ũ₁^{†}ũ₂|²/(∥ũ₁∥²∥ũ₂∥²) conditioned on hypothesis H₁ is evaluated below by holding angles θ, ϕ₁ and ϕ₂ fixed, which fixes the unit-norm vector ũ₁∥ũ₁∥=e^{jϕ}^{₁} cos θ e_{1,N}+e^{jϕ}^{₂} sin θ v_{⊥}. The following for the conditional mean and conditional variance of the random variable within the parenthesis can be verified:

$$E [ {( {e}^{j {ϕ}_{1}} cos θ {e}_{1 , N} + {e}^{j {ϕ}_{2}} sin θ {v}_{⊥} )}^{†} ( {x}_{1} {e}_{1 , N} + {x}_{2} ) \vert {H}_{1} , θ , {ϕ}_{1} , {ϕ}_{2} ] = {e}^{- j {ϕ}_{2}} cos θ {a}_{2} \sqrt{{s}^{†} {R}^{- 1} s} \\ var [ {( {e}^{j {ϕ}_{1}} cos θ {e}_{1 , N} + {e}^{j {ϕ}_{2}} sin θ {v}_{⊥} )}^{†} ( {x}_{1} , {e}_{1 , N} + {x}_{2} ) \vert {H}_{1} , θ , {ϕ}_{1} , {ϕ}_{2} ] = 1 \qquad ( 42 )$$

Thus,

$$[ \frac{{\vert {\tilde{u}}_{1}^{†} ( {x}_{1} {e}_{1 , N} + {x}_{2} ) \vert}^{2}}{{‖ {\tilde{u}}_{1} ‖}^{2}} \vert {H}_{1} , θ , {ϕ}_{1} , {ϕ}_{2} ] \\ {χ}_{1}^{2} ( {\vert {a}_{2} \vert}^{2} {s}^{†} {R}^{- 1} s {cos}^{2} θ ) \\ [ {‖ ( {x}_{1} {e}_{1 , N} + {x}_{2} ) ‖}^{2} \vert {H}_{1} , θ , {ϕ}_{1} , {ϕ}_{2} ] {χ}_{N}^{2} ( {\vert {a}_{2} \vert}^{2} {s}^{†} {R}^{- 1} s ) \qquad ( 43 )$$

With ũ₂=(x₁e_{1,N}+x₂), the random variable ũ₁^{†}ũ₂ and random vector ũ₂^{†} are not statistically independent and as such the two random variables on the left hand side above are not statistically independent. It can be verified however that a random variable yχ_{N}²(|a|²+|b|²) can be expressed as a sum of two statistically independent random variables y₁χ₁²(|a|²) and y₂χ_{N-1}²(|b|²). Thus, conditioned on H₁ and fixed θ, ϕ₁ and ϕ₂:

$$\begin{matrix}[ {‖ ( {x}_{1} {e}_{1 , N} + {x}_{2} ) ‖}^{2} \vert {H}_{1} , θ , {ϕ}_{1} , {ϕ}_{2} ] {χ}_{N}^{2} ( {\vert {a}_{2} \vert}^{2} {s}^{†} {R}^{- 1} s ) \\ {χ}_{1}^{2} ( {\vert {a}_{2} \vert}^{2} {s}^{†} {R}^{- 1} s {cos}^{2} θ ) + {χ}_{N - 1}^{2} ( {\vert {a}_{2} \vert}^{2} {s}^{†} {R}^{- 1} s {sin}^{2} θ ) \\ Therefore , & ( 44 ) \\ [ W ( {z}_{1} , {z}_{2} , R ) \vert {H}_{1} , θ , {ϕ}_{1} , {ϕ}_{2} ] = [ \frac{{\vert {\tilde{u}}_{1}^{†} {\tilde{u}}_{2} \vert}^{2}}{{‖ {\tilde{u}}_{1} ‖}^{2} {‖ {\tilde{u}}_{2} ‖}^{2}} \vert {H}_{1} , θ , {ϕ}_{1} , {ϕ}_{2} ] \\ \frac{{χ}_{1}^{2} ( {\vert {a}_{2} \vert}^{2} {s}^{†} {R}^{- 1} s {cos}^{2} θ )}{{χ}_{1}^{2} ( {\vert {a}_{2} \vert}^{2} {s}^{†} {R}^{- 1} s {cos}^{2} θ ) + {χ}_{N - 1}^{2} ( {\vert {a}_{2} \vert}^{2} {s}^{†} {R}^{- 1} s {sin}^{2} θ )} \\ {( 1 + \frac{{χ}_{N - 1}^{2} ( {\vert {a}_{2} \vert}^{2} {s}^{†} {R}^{- 1} s {sin}^{2} θ )}{{χ}_{1}^{2} ( {\vert {a}_{2} \vert}^{2} {s}^{†} {R}^{- 1} s {cos}^{2} θ )} )}^{- 1} & ( 45 )\end{matrix}$$

The distribution of random variable W in equation (45) does not depend on angles ϕ₁ and ϕ₂ and the conditioning on angle θ can be removed by averaging over the distribution of sin² θ in equation (41) and provides a basis for evaluating the pdf of [W(z₁,z₂,R)|H₁].

The required pdf of [W(z₁,z₂,R)|H₁] can be derived and expressed as a sum that involves the degenerate hypergeometric function, which is itself a sum. The approach is computationally burdensome and since the random variable in question is contained in the interval [0,1] it is significantly easier computationally to generate a large number of statistically independent realizations of the random variable W(z₁,z₂,R)|H₁] using the statistics derived in (45) and (41). The pdf is obtained from the realizations.

Appendix C

A generalized likelihood ratio test (GLRT) is derived for the hypotheses in equation (1). It is useful to consider a more general signal model in the hypothesis test than that in (1) as a slight digression (equation (1) corresponds to the special case M=1 and P=2):

$$Z = \{ \begin{matrix}X & if {H}_{0} \\ X + [ {s}_{1} {s}_{2} ⋯ {s}_{M} ] A & if {H}_{1}\end{matrix} \qquad ( 46 )$$

The complex N-dimensional vectors sₙ; n=1, 2, . . . , M are unknown unit-norm, linearly independent vectors and therefore, span an unknown M-dimensional subspace in C^{N×1}. A∈C^{M×P}; 1≤M≤P is a matrix of unknown complex weights. The rows of A are assumed to be linearly independent and so, the rank of A is M. It is assumed that N>P and as such the signal matrix for the hypothesis H₁ on the right hand side of equation (46) has rank M. Assume that the test vectors are Z∈C^{N×P}, the signal-free training vectors are Y∈C^{N×K}. The signal matrix in the matrix of test vectors is Q=[S₁ . . . s_{M}]A∈C^{N×P}. The rank of matrix Q is M which is the dimensionality of the signal subspace.

The joint probability density function conditioned on the null hypothesis H₀ is:

$$f ( Z , Y \vert R , {H}_{0} ) = \frac{{e}^{- Tr [ {R}^{- 1} [ {ZZ}^{†} + {YY}^{†} ] ]}}{{π}^{( K + P ) N} {\vert R \vert}^{( K + P )}} \qquad ( 47 )$$

R is the unknown covariance matrix of interference-plus-noise, Tr[ ] is the trace operator and † denotes the Hermitian transpose of a matrix. The interference model used here assumes that the various primary and secondary vectors are statistically independent and that the interference covariance matrix does not change over the P primary vectors. The primary and secondary data under the alternate hypothesis H₁ is given by:

$$f ( Z , Y \vert R , Q , {H}_{1} ) = \frac{{e}^{- Tr [ {R}^{- 1} [ ( Z - Q ) {( Z - Q )}^{†} + {YY}^{†} ] ]}}{{π}^{( K + P ) N} {\vert R \vert}^{( K + P )}} \qquad ( 48 )$$

Equations (47) and 48) denote likelihood functions, when the hypotheses H₀ and H₁ are viewed as the arguments and the remaining quantities fixed.

Under the null hypothesis H₀, the estimate \hat{R}₀=(ZZ^{†}+YY^{†})/(K+P) maximizes the likelihood function in (38). Similarly under the alternative hypothesis H₁ and assuming Q to be fixed the estimate \hat{R}₁=((Z−Q)(Z−Q)^{†}+YY^{†})/(K+P) maximizes the likelihood function in (48) Defining the random matrix S=YY^{†}, we have

$$\begin{matrix}{max}_{R} \text{:} f ( Z , Y \vert R , {H}_{0} ) = f ( Z , Y \vert R = {\hat{R}}_{0} , {H}_{0} ) \\ ∝ {\vert S + {ZZ}^{†} \vert}^{- ( K + P )} \\ = {\vert S \vert}^{- ( K + P )} {\vert {I}_{N} + ( {S}^{- 1 \text{/} 2} Z ) {( {S}^{- 1 \text{/} 2} Z )}^{†} \vert}^{- ( K + P )} \\ And , & ( 49 ) \\ {max}_{R} \text{:} f ( Z , Y \vert R , Q , {H}_{1} ) = f ( Z , Y \vert R = {\hat{R}}_{1} , Q , {H}_{1} ) \\ ∝ {\vert S + ( Z - Q ) {( Z - Q )}^{†} \vert}^{- ( K + P )} \\ = {\vert S \vert}^{- ( K + P )} {\vert {I}_{N} + {S}^{- 1 \text{/} 2} ( Z - Q ) {( Z - Q )}^{†} {S}^{- 1 \text{/} 2} \vert}^{- ( K + P )} & ( 50 )\end{matrix}$$

The proportionality constants in equations (49) and (50) are independent of the data and can be omitted and set to 1 in the last line of these equations. Let the singular value decomposition (SVD) of the matrix S^{-1/2}Z be given by the following:

$$\begin{matrix}{S}^{- 1 \text{/} 2} Z = {UDV}^{†} \\ = {\sum }_{k = 1}^{min ( P , N )} {d}_{k} {u}_{k} {v}_{k}^{†}\end{matrix} \qquad ( 51 )$$

U and V are unitary matrices whose columns are denoted by: uₖ; k=1, 2, . . . , N and vₖ; k=1, 2, . . . , P respectively. The matrix D is of size N×P whose diagonal elements are the singular values with the remaining elements being zeros. For N>P for example, the form of the matrix D is as shown below d₁≥d₂≥ . . . ≥d_{P}>0:

$$D = [ \begin{matrix}{D}_{1} \\ {0}_{( N - P ) \times P}\end{matrix} ] ; {D}_{1} = [ \begin{matrix}{d}_{1} & 0 & 0 & ⋯ & 0 \\ 0 & {d}_{2} & 0 & ⋯ & 0 \\ 0 & 0 & {d}_{3} & ⋯ & 0 \\ 0 & ⋯ & 0 & ⋱ & 0 \\ 0 & 0 & 0 & ⋯ & {d}_{P}\end{matrix} ] \qquad ( 52 )$$

The log-likelihood ratio with the respective estimates of the covariance matrices substituted in equations (49) and (50) is given by (the log-likelihood ratio is divided by K+P which does not change the test):

$$ln [ \frac{f ( Z , Y \vert R = {\hat{R}}_{1} , Q , {H}_{1} )}{f ( Z , Y \vert R = {\hat{R}}_{0} , {H}_{0} )} ] = ln [ \frac{\vert {I}_{N} + ( {UDV}^{†} ) {( {UDV}^{†} )}^{†} \vert}{\vert {I}_{N} + ( {UDV}^{†} - {S}^{- 1 \text{/} 2} Q ) {( {UDV}^{†} - {S}^{- 1 \text{/} 2} Q )}^{†} \vert} ] \qquad ( 53 )$$

The rank of Q is known to be M and so setting S^{-1/2}Q=Σₘ₌₁^{M}dₘuₘvₘ^{†} in the denominator above maximizes the log-likelihood function.

$$ln [ \frac{f ( Z , Y \vert R = {\hat{R}}_{1} , {S}^{- 1 \text{/} 2} Q = {\sum }_{m = 1}^{M} {d}_{m} {u}_{m} {v}_{m}^{†} , {H}_{1} )}{f ( Z , Y \vert R = {\hat{R}}_{0} , {H}_{0} )} ] = ln [ \frac{{\prod }_{k = 1}^{P} ( 1 + {d}_{k}^{2} )}{{\prod }_{k = M + 1}^{P} ( 1 + {d}_{k}^{2} )} ] = {\sum }_{m = 1}^{M} ln ( 1 + {d}_{m}^{2} ) = {\sum }_{m = 1}^{M} ln ( 1 + {λ}_{m} ) \qquad ( 54 )$$

In the above equation λₘ=dₘ²; m=1, 2, . . . M. And from equation (51) are the largest M eigenvalues of the matrix Z^{†}S⁻¹Z (i.e. λ₁≥λ₂≥ . . . ≥λ_{M}). In the special case of M=1, where the additive signal in each observation is an unknown vector that may be scaled arbitrarily—referred to as signals being matched—the test statistic of the GLRT is d₁²=λ₁. From equation (51), d₁ is the maximum singular value obtained from a SVD of S^{-1/2}Z. Note that the square of the maximum singular value 4 is equal to the maximum eigenvalue (λ₁) of the P×P hermitian matrix Z^{†}S⁻¹Z. And since any function of the test statistic that is monotonically related to the test statistic in equation (54) is also a test statistic, the GLRT is given by the following test:

λ₁η_{GLRT} (55)

Similarly, for M=2 the test statistic is formed from the two largest eigenvalues λ₁ and λ₂ of Z^{†}S⁻¹Z and the hypothesis test is:

ln(1+λ₁)+ln(1+λ₂)η_{GLRT} (56)

Characterizing the pdf of the test statistic conditioned on hypothesis H₀ to determine the threshold to set the P_{FA} requires the joint pdf of the two largest eigenvalues λ₁ and λ₂ and is unknown at the present time.

Cited References which are hereby incorporated by reference in their entirety:

### REFERENCES

[1] E. J. Kelly, “An Adaptive Detection Algorithm,” IEEE Trans. on Aerospace and Electronic Systems, vol. AES-22, no. 1, pp. 115-127, March 1986.
[2] C. G. Khatri and C. R. Rao, “Effects of estimated noise covariance matrix in optimal signal detection,” IEEE Trans. on Acoustics Speech and Signal Processing, vol. 35, no. 5, pp. 671-679, May 1987.
[3] E. J. Kelly, K. M. Forsythe, “Adaptive Detection And Parameter Estimation For MultiDimensional Signal Model,” Technical Report #848, MIT Lincoln Laboratory, April 1989.
[4] F. C. Robey, D. R. Fuhrmann, E. J. Kelly and R. Nitzberg, “A CFAR Adaptive Matched Filter Detector,” IEEE Trans. on Aerospace and Electronic Systems, vol. AES-28, no. 1, pp. 208-216, January 1992.
[5] S. Z. Kalson, “An Adaptive Array Detector with Mismatch Signal Rejection,” IEEE Trans. on Aerospace and Electronic Systems, vol. AES-28, no. 1, pp. 195-207, January 1992.
[6] I. S. Reed and Y. L. Gau, “Noncoherent Summation of Multiple Reduced-Rank Test Statistics for Frequency-Hopped STAP,” IEEE Trans. Signal Process., vol. 47, no. 6, pp. 1708-1710, June 1999.
[7] L. L. Scharf and B. Friedlander, “Matched Subspace Detectors,” IEEE Trans. Signal Process., vol. 42, no. 8, pp. 2146-2157, August 1994.
[8] S. Bose, A. Steinhardt, “A Maximal Invariant Framework for Adaptive Detection with Structured and Unstructured Covariance Matrices,” IEEE Trans. on Signal Processing, vol. SP-43, no. 9, pp. 2164-2175, September 1995.
[9] S. Bose, A. Steinhardt, “Optimum Array Detector for a Weak Signal in Unknown Noise,” IEEE Trans. on Aerospace and Electronic Systems, vol. AES-32, no. 3, pp. 911-922, July 1996.
[10] R. S. Raghavan, N. B. Pulsone and D. J. McLaughlin, “Performance of the GLRT for Adaptive Vector Subspace Detection,” IEEE Trans. on Aerospace and Electronic Systems, vol. AES-32, no. 4, pp. 1473-1487, October 1996.
[11] S. Kraut and L. L. Scharf, “The CFAR adaptive subspace detector is a scale-invariant GLRT,” IEEE Trans. Signal Processing, vol. 47, no. 9, pp. 2538-2541, September 1999.
[12] F. Gini and A. Farina, “Matched Subspace CFAR Detection of Hovering Helicopters,” IEEE Trans. on Aerospace and Electronic Systems, vol. AES-35, no. 4, pp. 1293-1305, October 1999.
[13] N. B. Pulsone and R. S. Raghavan, “Analysis of an Adaptive CFAR Detector in Non-Gaussian Interference,” IEEE Trans. on Aerospace and Electronic Systems, vol. AES-35, no. 3, pp. 903-916, July 1999.
[14] C. D. Richmond, “Performance of the Adaptive Sidelobe Blanker Detection Algorithm in Homogeneous Environments,” IEEE Trans. on Signal Processing, vol. 48, no. 5, pp. 1235-1247, May 2000.
[15] N. B. Pulsone and M. A. Zatman, “A computationally efficient two-step implementation of the GLRT,” IEEE Trans. Signal Processing, vol. 48, no. 3, pp. 609-616, March 2000.
[16] S. Kraut, L. L. Scharf, and T. McWhorter, “Adaptive Subspace Detector,” IEEE Trans. Signal

Process., vol. 49, no. 1, pp. 1-16, January 2001.
[17] N. B. Pulsone and C. M. Rader, “Adaptive Beamformer Orthogonal Rejection Test,” IEEE Trans. Signal Processing, vol. 49, no. 3, pp. 521-529, March 2001.
[18] O. Besson and L. L. Scharf, “CFAR Matched Direction Detector,” IEEE Trans. Signal

Processing, vol. 54, no. 7, pp. 2840-2844, July 2006.
[19] A. De Maio, “Rao Test for Adaptive Detection in Gaussian Interference With Unknown Covariance Matrix,” IEEE Trans. Signal Processing, vol. 55, no. 7, pp. 3577-3584, July 2007.
[20] A. De Maio and E. Conte, “Adaptive detection in gaussian interference with unknown covariance after reduction by invariance,” IEEE Transactions on Signal Processing, vol. 58, no. 6, pp. 2925-2934, June 2010.
[21] R. S. Raghavan, “Maximal Invariants and Performance of Some Invariant Hypothesis Tests for an Adaptive Detection Problem,” IEEE Trans. on Signal Processing, vol. 61, no. 14, pp. 3607-3619, July 2013.
[22] R. S. Raghavan, “Analysis of Steering Vector Mismatch on Adaptive Noncoherent Integration,” IEEE Trans. on Aerospace and Electronic Systems, vol. 49, no. 4, pp. 2496-2508, October 2013.
[23] R. S. Raghavan, “False Alarm Analysis of the AMF Algorithm for Mismatched Training,” IEEE Trans. on Signal Processing, vol. 67, no. 1, pp. 83-96, January 2019.
[24] F. Gini and M. Greco, “Covariance matrix estimation for CFAR detection in correlated heavy tailed clutter,” Signal Processing, vol. 82, no. 12, pp. 1847-1859, December 2002.
[25] R. S. Raghavan, “Statistical Interpretation of a Data Adaptive Clutter Subspace Estimation Algorithm,” IEEE Trans. on Aerospace and Electronic Systems, vol. 48, no. 2, pp. 1370-1384, April 2012.
[26] R. S. Raghavan, “CFAR Detection in Clutter With a Kronecker Covariance Structure,” IEEE Transactions on Aerospace and Electronic Systems, vol. 53, no. 2, pp. 619-629, April 2017.
[27] J. S. Goldstein and I. S. Reed, “Reduced-Rank Adaptive Filtering,” IEEE Transactions on Signal Processing, vol. 45, no. 2, pp. 492-496, February 1997.
[28] J. S. Goldstein and I. S. Reed, “Subspace Selection for Partially Adaptive Sensor Array Processing,” IEEE Transactions on Aerospace and Electronic Systems, vol. 33, no. 2, pp. 539-544, April 1997.
[29] J. R. Guerci, J. S. Goldstein and I. S. Reed, “Optimal and Adaptive Reduced-Rank STAP,” IEEE Transactions on Aerospace and Electronic Systems, vol. 36, no. 2, pp. 647-663, April 2000.
[30] I. S. Reed, J. D. Mallett, and L. E. Brennan, “Rapid convergence in adaptive arrays,” IEEE Trans. on Aerospace and Electronic Systems, Vol. AES-10, no. 6, 1974, pp. 853-863.
[31] C. D. Richmond, “Performance of a Class of Adaptive Detection Algorithms in Nonhomogeneous Environments,” IEEE Trans. on Signal Processing, vol. 48, no. 5, pp. 1248-1262, May 2000.
[32] S. Kraut, L. L. Scharf, and R. W. Butler, “The Adaptive Coherence Estimator: A Uniformly Most-Powerful-Invariant Adaptive Detection Statistic,” IEEE Trans. Signal Process., vol. 53, no. 2, pp. 427-438, February 2005.
[33] S. Bidon, O. Besson and J-Y Tourneret, “The Adaptive Coherence Estimator is the Generalized Likelihood Ratio Test for a Class of Heterogeneous Environments,” IEEE Signal Processing Letters, vol. 15, pp. 281-284, 2008.
[34] R. S. Raghavan, S. Kraut and C. D. Richmond, “Subspace Detection for Adaptive Radar: Detectors and Performance Analysis,” Chapter 3 of Modern Radar Detection Theory, Edited by A. De Maio and M. Greco, 2016 SciTech Publishing.
[35] C. G. Khatri, “Classical Statistical analysis based on certain multivariate complex Gaussian distributions,” Annals of Mathematical Statistics, vol. 36, pp. 98-114, 1965.
[36] A. K. Gupta, “Noncentral Distribution of Wilks' Statistic in MANOVA,” Annals of Mathematical Statistics, vol. 42, no. 4, pp. 1254-1261, 1971.
[37] M. S. Srivastava, “On the distribution of a multiple correlation matrix: Non-central multivariate beta distributions,” The Annals of Mathematical Statistics, vol. 39, no. 1, pp. 227-232, 1968.
[38] M. S. Srivastava, “Correction to: On the distribution of a multiple correlation matrix: Non-central multivariate beta distributions,” The Annals of Mathematical Statistics, vol. 39, no. 1, pp. 227-232, 1968.
[39] S. K. Katti, “Distribution of the likelihood ratio testing multivariate linear hypotheses,” The Annals of Mathematical Statistics, vol. 32, no. 1, pp. 333-335, March, 1961.
[40] A. M. Kshirsagar, “The Non-central Multivariate beta distribution,” The Annals of Mathematical Statistics, vol. 32, no. 1, pp. 104-111, March, 1961.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A radar system comprising: a transmitter that transmits a sequence of transmitted pulses in a transmit beam; receiving antenna array comprised of more than one element; a receiver communicatively coupled to the receiving antenna area to receive received signal that comprises in-phase and quadrature samples collected of a reflected version of the sequence of transmitted pulses; a signal processing and target detection module that resolves a received signal-plus-interference into different range cells based on a time delay between the transmitted pulse and the received signal, wherein a response from a range cell to a transmitted pulse is due to a target within the transmit beam and moving at an unknown velocity, the in-phase and quadrature samples collected over a sequence of transmitted pulses and across the elements of the receiving antenna array correspond to the space-time samples of a coherent processing interval (CPI) for a specific range cell; and an interference suppression module that suppresses interference and test for presence of a target tested at each of a set of hypothesized azimuth angles and Doppler frequencies.
